(19) United States
(12) Patent Application Publication
(10) Pub. No.: US 2007/0182155 A1
(43) Pub. Date: Aug. 9, 2007

(54) Combination greeting card impermanently engaged with a mailer having means for carrying an item of value

(76) Inventor: Celina Taganas Duffy, Los Angeles, CA (US)

Correspondence Address: PATENT LAW & VENTURE GROUP, 2424 S.E. BRISTOL, SUITE 300, NEWPORT BEACH, CA, 92660, US

(21) Appl. No.: 11/348,834

(22) Filed: Feb. 6, 2006

(51) Int. Cl. B42D 15/00

(52) U.S. Cl. 283/116

(57) ABSTRACT

A greeting card apparatus includes a greeting card portion impermanently attached to, but not contiguous with, a first panel of a mailer portion; the mailer portion being of such size and shape, and the card portion positioned on the first panel in such position whereby the mailer portion can be folded about the card portion and sealed for mailing. Upon receipt, the card portion may be easily removed from the mailer portion. The mailer portion is facilitated for including a gift card, a business card or other item.

### BACKGROUND OF THE INVENTION

1. Field of the Present Disclosure

This disclosure relates generally to greeting cards, and more particularly to greeting card-mailer combinations.

Description of Related Art including information disclosed under 37 CFR 1.97 and 1.98

Collins, U.S. Pat. No. 6,725,587, discloses a combination envelope and greeting card having a detachable card structure which is removable from the envelope and can function separately as a greeting card. Portions of some of the panels of the envelope can be separated from the envelope along lines of perforation, forming cards having two or more panels. The combination envelope and greeting card structure can also comprise a detachable display strip that includes an adhesive display assembly for securing the card structure when displayed in a standing position. Photograph retaining structures can also be included on one or more card panels. Brewster, U.S. Pat. No. 5,641,115, discloses a combination greeting card and envelope formed from a unitary sheet of material. The combination greeting card and envelope has a main card panel with a front face and a rear face, a pair of side doors, one each extending from side edges of the main card panel, with the pair of side doors being sized to generally overlay at least a portion of the front and rear faces of the main card panel. A closure panel having a front and back side extends from a top edge of the main card panel, with the closure panel being sized to be overlaid on to the main card panel. A retention flap extends from a top edge of the closure panel. In use, the combination greeting card and envelope is designed to be folded for display on a retail rack, folded for mailing, and folded for display by the end user. Cruz, U.S. Pat. No. 5,135,157, discloses a combined envelope and greeting card which consists of a greeting card configuration, a mechanism for sealing the greeting card configuration, so that it can be transformed into an envelope configuration to be properly addressed by an addresser and then mailed to an addressee and a mechanism for breaking the sealing mechanism, so that the envelope configuration can be transformed back into the greeting card configuration by the addressee. Coleman, U.S. Pat. No. 4,186,868, discloses an envelope for sending a written message with a photograph attached thereto. An adhesive is provided on one flap for attaching a photograph; the flap can then be folded so that the photograph is over the writing surface. Other flaps fold over the photograph so that the photograph is shielded in its entirety.

The related art described above discloses various greeting card-envelope combinations including combinations made from a single piece of card stock paper able to be folded for mailing and with a greeting card portion able to be separated from a mailer portion. However, the prior art fails to disclose a combination greeting card impermanently engaged with an envelope having means for attachment of a removable item such as a business card or a gift card, etc. The presently described apparatus distinguishes over the prior art providing advantages as described in the following summary.

### BRIEF SUMMARY OF THE INVENTION

This disclosure teaches certain benefits in construction and use which give rise to the objectives described below.

Greeting card manufacturers focus on producing attractive and selective subject matter in cards which are almost always separate from an associated envelope within which they are to be mailed. The card is directed to delivering a message and the envelope is directed to carrying the card through the mailing process. These individual and separate elements are each directed to a distinct objective. Individual cards are also available with pockets for enclosing cash or check.

The present invention is a greeting card apparatus which includes a greeting card portion impermanently attached to, but not contiguous with, a first panel of a mailer portion; the mailer portion being of such size and shape, and the card portion positioned on the first panel in such manner, whereby the mailer portion can be folded about the card portion and sealed for mailing. Upon receipt, the card portion may be easily removed from the mailer portion. The mailer portion may be facilitated for including a gift card, a business card or other item of value.

A primary objective inherent in the above described apparatus and method of use is to provide advantages not taught by the prior art.

Another objective is to provide a mailable greeting card that is impermanently engaged with a mailer, the mailer being physically separate and a separable sheet of card stock from that of the card;

A further objective is to provide such a card-mailer wherein the card is detachable from the mailer after being received by an addressee;

A still further objective is to provide such a card-mailer that also has facility for carrying a gift or business card or other item.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the presently described apparatus. In such drawing(s):

FIGS. 1 and 2 are plan views of the apparatus as unfolded showing an obverse and a reverse sides respectively;

FIG. 3 is a perspective view thereof showing a folding method;

FIG. 4 is a perspective view thereof showing the apparatus folded ready for mailing;

FIG. 5 is a perspective view thereof showing the apparatus as received through the mails, essentially the same as FIG. 4;

FIG. 6 is a perspective view thereof showing a method of opening the apparatus with one strip on the right side removed and one strip on the left side being removed;

FIG. 7 is a plan view of the obverse side thereof with the left and right side strips removed; and

FIGS. 8, 9 and 10 are partial view of the obverse side thereof showing respectively: a corner mounting method for holding a business or gift card, a pocket mounting method for holding a business or gift card, and an embodiment wherein an adhesive is used for holding the business or gift card.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

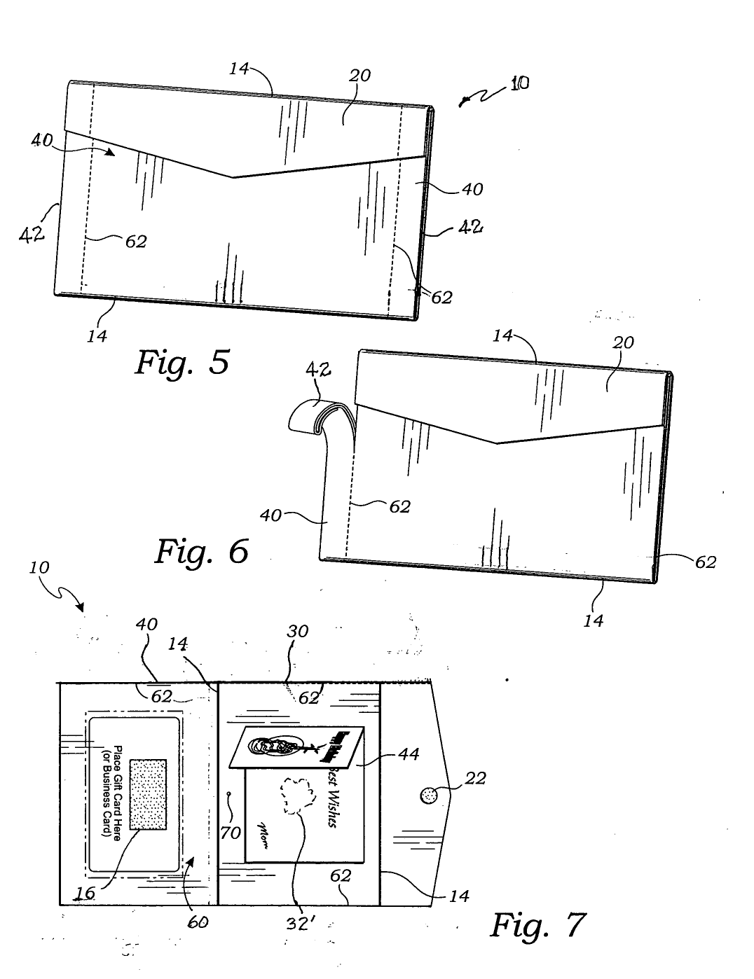

Described now in detail is a greeting card and mailer apparatus 10 made of paper or plastic sheet stock. A greeting card portion 44 of the apparatus is impermanently attached to a first panel 30 of a mailer portion 20 of the apparatus 10. The use of the term “greeting card” 44 is used generically here and throughout the claims, but, for instance such a “greeting card” may be also a blank card, a thank you card, an invitation card or any such similar type of card, all herein referred to by the use of “greeting card portion” or simple “card portion.” The card portion 44 may be of any common type and preferably a folded two panel type with its panels one behind the other as best seen in FIG. 7. Clearly, the card's panels may be arranged to open right to left or bottom to top as is well known. The card portion 44 may alternately be of the single panel type as well. The mailer portion 20 is of such size and shape, as shown, and the card portion 44 is positioned on the first panel 30 so that the mailer portion 20 can be folded about the card portion 44 and sealed for mailing, see FIG. 5.

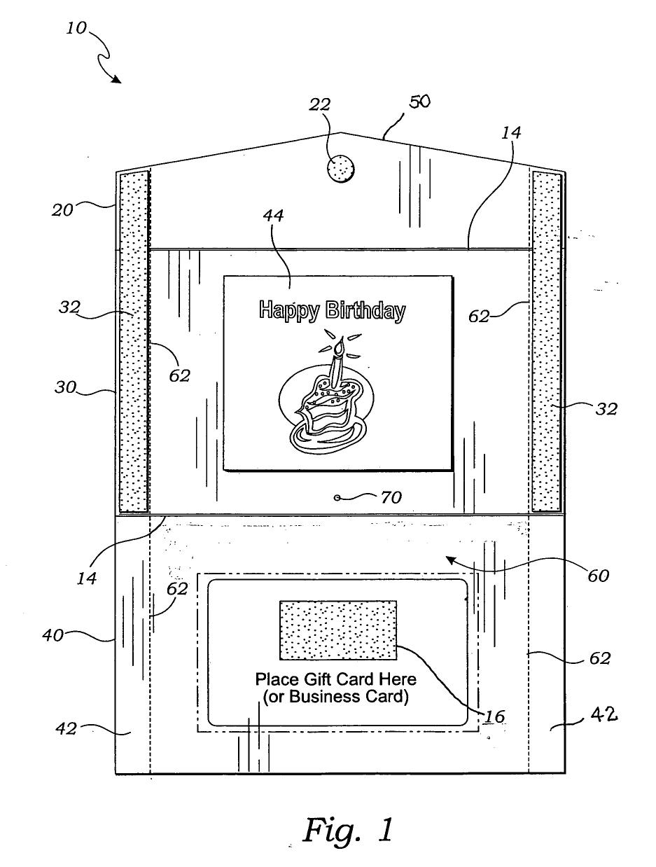

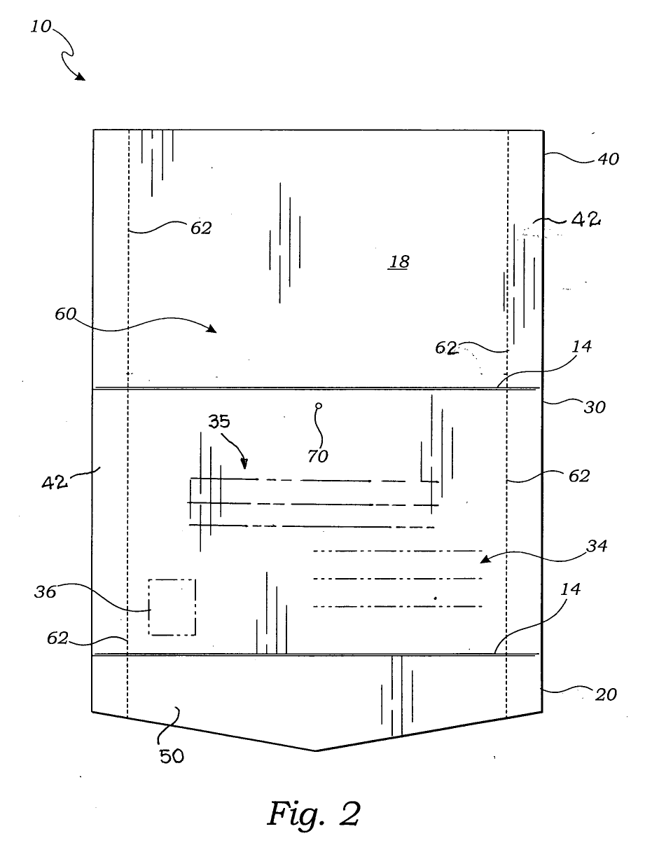

The mailer portion 20 provides fold creases 14 adjacent two opposing sides of the card portion 44 and provides perforations 62 adjacent two further opposing sides of the card portion 44 as is clearly shown in FIGS. 1 and 2. The perforations 62 define opposing sealing strips 42 of the mailer portion 20, the sealing strips providing a sealing adhesive 32 for sealing the mailer portion 20 as will be described below.

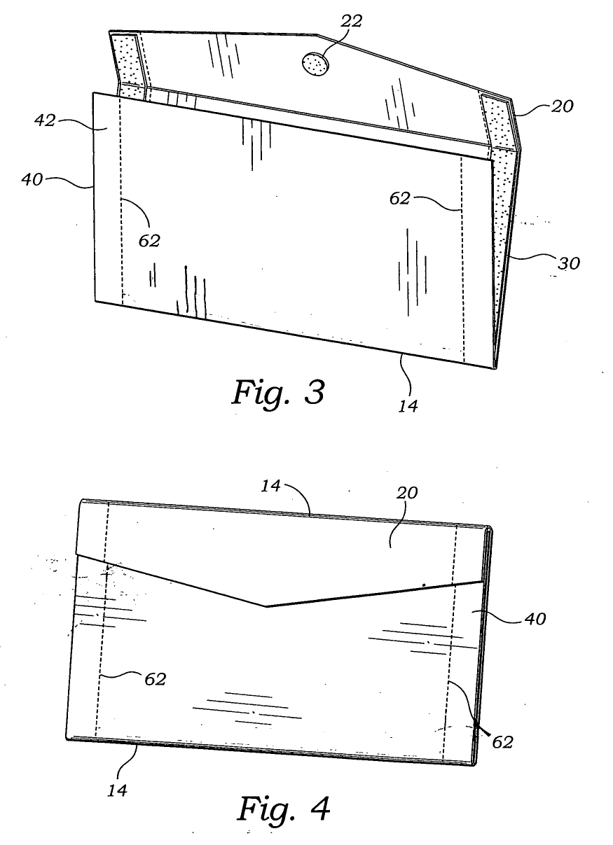

The fold creases 14 define opposing second 40 and third 50 panels of the mailer portion 20 each contiguous with the first panel 30 of the mailer portion and preferably part of a common sheet of paper stock. The second panel 40 is operable and sized for covering at least a portion, and preferably all of the card portion 44. The third panel 50 is operable and sized as a closure flap and preferably therefore provides further sealing adhesive 22 in the form of a dot (shown) or strip or other effective shape for sealing the mailer portion 20 as shown in FIGS. 3 and 4.

The card portion 44 is preferably attached to the obverse side 60 of the first panel 30 of the mailer portion 20 with a daub of an impermanent adhesive 32′ as shown in FIG. 7. Such adhesive may be of the type used on the well known Post-It® notes provided by the 3M Company, or any equivalent, providing a long-lasting adhesive quality while being easy to separate the two adhered surface. Alternatively, the card portion 44 may be attached to the mailer portion 20 by other fastening means such as by double sided adhesive tape, staples or similar means not requiring severing the card portion 44 from the mailer portion 20 along perforated lines. In one preferred embodiment the card portion 44 may be advantageously stapled to the mailer portion 20 at the fold crease 14 between the first 30 and second 40 panels.

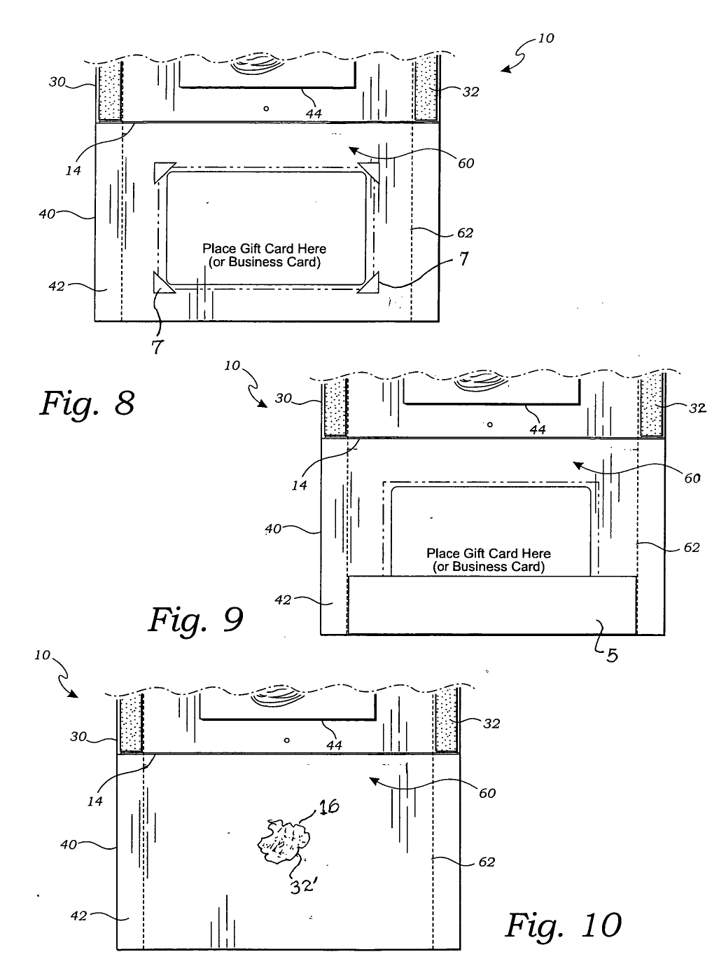

Preferably, the second panel 30 provides an engagement element 16 for impermanently engaging an item such as a gift card, business card, paper money or a note, letter, cosmetic sample, photograph, or any other item preferably made of paper or flat plastic card stock. The element 16 may be a pocket 5 (FIG. 9), a set of opposing mounting comers 7 (FIG. 8), or an daub of the impermanent adhesive 32′ (FIGS. 1 and 10).

The apparatus 10 preferably has directive indicia printed on the obverse side 60 and the reverse side 18 as shown in FIGS. 1, 2, and 7-10. Such indicia preferably includes directive indicia placed on the obverse side of the second panel 40 for indicating what item shall be placed thereon or therein and where said item shall be placed or located and for indicating a donor, a recipient and an amount of money enclosed. Also, such directive indicia preferably includes, on the reverse side 18, of the first panel 30 for indicating where a postage stamp shall be placed 36 and at least one of a return address 34 and a forwarding address 35. See FIG. 2.

In use, the card portion 44 is filled out by the purchaser in a manner identical to any greeting card. If the mailing portion is of the type shown in FIGS. 1 and 7-10, the purchaser has the option of engaging an item such as a money, a gift card or a business card with the mailer portion 20. Alternately, the apparatus 10 may be purchased with an item already attached, such as a gift card. The purchaser then strips peel-away cover portions (not shown) that cover the adhesive 32 and folds the panel 40 along the upper fold crease 14 so that it covers the card portion 44 and then seals the left and right edges using finger pressure. Finally with peel-away cover portions (not shown) covering the adhesive 22 on panel 50, panel 50 is folded down, along the upper fold crease 14 over panel 40 and sealed. The return addresses may then be placed at the indicia on the obverse side 18 of panel 30 at lines 34 (FIG. 2) along with a mailing address of the recipient below the return address, a postage stamp placed at indicia 36, and the apparatus is mailed as shown in FIG. 5. Because the apparatus is fully sealed any air trapped within may force the seals of the mailing portion to break open when the mailer is drawn between nip rolls at the post office sorting room. Therefore, a small hole 70 (FIG. 2) is placed as shown to allow trapped air to escape without forcing any of the seals to open.

When the present apparatus is received by the recipient it may be opened in the standard way with a letter opener and the card portion removed in the standard manner as well. However, if the card portion 44 and/or an item such as a gift card is adhered within the mailer portion 20, it is opened by tearing away the side strips along the perforations 62, as shown in FIG. 6 as well as opening the third panel 50 conventionally or by overcoming the adhesive, so that the second 40 and third 50 panels are folded open and into the same plane as the first panel 30 as shown in FIG. 7, to reveal the card portion 44 enclosed as well as the item enclosed. The card portion 44 is then removed from the mailer portion 20 by breaking the impermanent adhesive bond. The enclosed item is also removed from the mailer portion 20 and the mailer portion 20 is then discarded.

Throughout this description we have referred to the card portion 44 as being attached to the first panel 30. However, it would be obvious to those of skill in the art that the card portion 44, may be attached to the second 40 or even the third 50 one of the panels, the primary objective being to provide the card portion within a folding mailer where the card portion 44 is a separable entity easily removed from the mailer portion 20. Likewise, the sent element, i.e., the gift card, etc. and the receiving element, i.e., the pocket, corners or adhesive may be attached to any one of the panels 30, 40, 50 as well.

In a further preferred embodiment, the card portion 44 may be provided as a plurality of such portions 44 separately boxed and sold, as is well known in the art. Likewise, the mailer portion 20 may be boxed and sold in a plurality thereof, the later being akin in purpose to commercially available boxed envelopes. Still further, it should be clear that the card portions 44 in plurality and the mailer portion 20 in plurality may be combined and commercially made available in boxes sets.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A greeting card apparatus comprising: a greeting card portion impermanently attached to, but not contiguous with, a first panel of a mailer portion; the mailer portion of such size and shape, and the card portion positioned on the first panel in such position whereby the mailer portion can be folded about the card portion and sealed for mailing, the card portion being thereby fully contained within the mailer portion.

2. The apparatus of claim 1 wherein the mailer portion provides fold creases adjacent two opposing sides of the card portion and further provides perforations adjacent two further opposing sides of the card portion.

3. The apparatus of claim 2 wherein the perforations define opposing sealing strips of the mailer portion, the sealing strips providing a sealing adhesive covering at least a portion of the sealing strips.

4. The apparatus of claim 2 wherein the fold creases define opposing second and third panels each contiguous with the first panel of the mailer portion, the second panel operable by folding for covering at least a portion of the card portion, the third panel operable by folding as an envelope closure flap, the closure flap providing further sealing adhesive for sealing the third panel with the second panel.

5. The apparatus of claim 1 wherein the card portion is attached to the first panel of the mailer portion with an impermanent adhesive.

6. The apparatus of claim 4 wherein the second panel provides an engagement element for impermanently engaging an item, the engagement element comprising at least one of: at least one pocket, opposing comer mounts and an impermanent adhesive, the engaged item comprising at least one of: at least one business card, at least one gift card, at least one piece of monetary currency, at least one cosmetic sample, at least one note, and at least one photograph.

7. The apparatus of claim 1 wherein the mailer portion provides fold creases adjacent two opposing sides of the card portion and provides perforations adjacent two further opposing sides of the card portion, wherein the fold creases define opposing second and third panels each contiguous with the first panel of the mailer portion, the second panel operable for covering the card portion, the third panel operable as a closure flap.

8. The apparatus of claim 7 further comprising directive indicia including at least one of: directive indicia on the second panel thereby indicating what and where an item shall be engaged therewith; directive indicia on the second panel for receiving a further indicia identifying a donor, a recipient and an amount of money enclosed; and directive indicia on the first panel thereby indicating postage stamp, return address and forwarding address locations.

9. The apparatus of claim 1 wherein at least one of the first, second and third panels provides at least one air exhaust hole.

10. A paper stock greeting card mailer apparatus comprising, as a single unit or as a plurality thereof: a first, second and third panels; a means for impermanent engagement of a greeting card with at least one of the panels; the second and third panels, contiguous with the first panel and separated therefrom by fold creases enabling the second and third panels to be folded over the first panel so as to fully enclose the greeting card; the panels further providing perforations defining opposing sealing strips incorporating a sealing adhesive covering at least a portion of the sealing strips; one of the second and third panels providing further sealing adhesive for sealing the one of the second and third panels with the other of the second and third panels when the second and third panels are folded over the first panel so as to enclose the greeting card.

11. The apparatus of claim 10 wherein one of the panels further provides a further means for impermanent engagement for impermanently engaging an item, the further engagement means comprising at least one of: at least one pocket, opposing comer mounts and an impermanent adhesive, the engaged item comprising at least one of: at least one business card, at least one gift card, at least one piece of monetary currency, at least one cosmetic sample, at least one note, and at least one photograph.

12. The apparatus of claim 11 further comprising directive indicia including at least one of: directive indicia indicating what and where the engaged item shall be engaged therewith; directive indicia identifying a donor, a recipient and an amount of money enclosed; and directive indicia indicating postage stamp, return address and forwarding address locations.
